(19) United States
(12) Patent Application Publication
(10) Pub. No.: US 2005/0284419 A1
(43) Pub. Date: Dec. 29, 2005

(54) Fabric-covered pet collar

(76) Inventor: Theresa Marie Bazar, Los Angeles, CA (US)

Correspondence Address: Theresa M. Bazar, 11822 Gorham Avenue #2, Los Angeles, CA, 90049, US

(21) Appl. No.: 10/878,874

(22) Filed: Jun. 28, 2004

(51) Int. Cl. A01K 27/00

(52) U.S. Cl. 119/856

(57) ABSTRACT

Smart Design of Los Angeles, Calif. has developed a specific method of constructing and finishing fabric-covered pet collars. The specific construction method is the only construction method, which will produce the collar described below. The construction method is intended for manufacturing pet collars. The collar is comprised of two strips of filler banding materials(s), which make the outer, and inner collar bands. Each individual band is cleanly wrapped over and around with fashionable fabric using a specific method, which produces a perfectly clean, finished outside appearance on all three planes of the collar: namely the inner plane, outer plane, and side planes after the collar has been closed. The specific construction method teaches a superior finishing method for the ends of the collar band; including a method for creating a triangular point shape at one end intended for eyelet's or holes and a superior finishing method for the opposite end creating a turn back intended for the application of hardware: such as a buckle or similar closure, belt loop or d-ring and rivets.

### CROSS-REFERENCE TO RELATED APPLICATIONS

Cross-reference design patent application 29/199,520, filed on Feb. 18, 2004 for the Bow Collar, a pet collar designed and created by Smart Design of Los Angeles, Calif.

### FEDERALLY SPONSORED RESEARCH AND DEVELOPMENT

None

### SEQUENCE LISTING OR PROGRAM

There is no sequence listing of program.

### TECHNICAL FIELD OR BACKGROUND

This invention relates to pet (animal) collars. Specifically it is a method of constructing fabric-covered pet collars.

### BACKGROUND ART AND BRIEF SUMMARY

Pet collars have probably been around as long as people have been domesticating animals and making them household pets. Recently, people have been making collars out of cut leather strapping and a product known as webbing. Webbing is nylon filament woven into a wide, flattened strand, similar to a flattened rope. Most webbing is dyed in basic, solid colors, such as red, blue, and green. Both leather and webbing are satisfactory in their functional aspect, but lack fashionable creativity.

Some pet collars referred to as fashion collars are made of webbing, which has been printed on with designs such as smiley faces, and dog bones. There are also fashion collars made of webbing which have decorative ribbon sewn down on top of the webbing. And, there are webbing collars that have designs woven into it. The printed webbing collars are cute, but too limited in design and color. The collars with the decorative ribbon sewn on them are attractive but will snag in usage due to the nature of the ribbon. Ribbon has a satin stitch which easily snags and runs and will definitely snag when the pet scratches. The best of the fashion collars are the ones made of webbing with designs woven into it. These too, are attractive, but quite limited in color and design.

The leather collars, which are made of cut and treated leather are quite handsome, but extremely limited in color, have no print, and are basically of masculine appearance.

The closest prior art to the fabric-covered pet collar designed and developed by Smart Design of Los Angeles, Calif. is the fabric-covered belt, which is occasionally seen on items of apparel. These belts are poorly constructed and are ordinarily manufactured with inferior (very inexpensive) products. They do have an outer belt comprised of inexpensive filler belting (a strip of material strapping) which is covered with fabric. This filler belting is one thickness and is ordinarily a board like recycled paper product made especially for these belts. It is definitely not suitable for pet collars. It is not washable, and is too stiff for pet collars. Additionally, if the collar is accidentally folded, a crease may appear. There are also fabric-covered belts, comprised of fabric, which is cut and glued onto rigid plastic belting. This plastic is too rigid for a pet collar, possibly cutting into the pets' neck. I think cats and dogs need a soft, pliable collar for daily wear. I am sure this is why webbing has been used successfully in manufacturing pet collars. Also, the rigid plastic belt has cut (raw) fabric and vinyl edges showing to the outside of the belt at the side planes; producing an inferior outer belt finish visually. The most common fabric covered belt is one that is comprised of the recycled paper belting product being covered with fabric and the inside belt being finished with a cut vinyl piece shaped like the outside belt. This belt has cut raw vinyl edges showing to the outside of the belt; also an inferior finish. The specific method of constructing and finishing fabric covered pet collars by Smart design of Los Angeles, Calif. produces a pet collar which boasts a luxurious, perfectly clean, superior finished quality on all three planes of the finished collar. The three planes are the outside plane (outer collar band), inside plane (inner collar band), and side planes (cross section). The resulting collar is one that is soft, pliable, perfectly finished, with fabric and is visibly clean on all sides of the collar.

My fabric-covered pet collars can be considered “designer” collars because this type of pet collar can vary considerably in color, print, texture, quality, design and design application, from season to season, like fashionable clothing, by changing the fabric. Currently, there are no pet collars on the market like mine. My fashionable pet collars are produced from carefully chosen fabrics, which are fashionable and durable, such as nylon, polyester, cotton, wool and even vinyl. My fabric-covered pet collars can be cleaned like clothing and can include care instructions on care labels or on the packaging. My fabric-covered pet collars come with matching leashes that can be cared for in the same way.

These design advantages are what led me to create the specific method of constructing and finishing fabric-covered pet collars. I would like to patent this specific method.

### DETAILED DESCRIPTION OF THE INVENTION

A specific construction method is used in making and manufacturing fabric-covered pet collars by Smart Design of Los Angeles, Calif. The preferred embodiment is a collar comprised of 2 pieces of filler banding material(s). One will make the outer collar band and the other will make the inner collar band. Fashionable fabric cleanly covers over and around both filler bands. A specific finishing method is applied to the ends of the collar creating a triangular point shape at one end of the collar which may have eyelet's or holes, and a turn back end opposite the point shape intended for the application of hardware including a buckle or some similar closure device, belt loops or d-rings, and rivets. Using this specific construction method which is referenced in the specification; and only this specific construction method produces a perfectly clean finished outside appearance on all 3 planes of the collar band when the collar is complete. The three planes are the top plane or outside collar, the under plane or inside collar and the side plane of the collar.

The pet collar by Smart Design of Los Angeles, Calif. is a fabric-covered pet collar with no raw, cut, fabric or vinyl edges to the outside of the collar band on all three planes, and no inside construction visible to the outside when it is stitched and riveted closed. It is a luxurious fabric-covered pet collar with a perfectly clean, pliable, collar with a superior finish when the collar band has been stitched and riveted closed.

### DRAWINGS

FIGS. 1a through 1d show the various views of the fabric-covered pet collar.

FIG. 1a shows a view of the outside plane of a fabric-covered pet collar finished with hardware. Reference #1 is the buckle, reference #2 is for the rivets, reference #3 is the belt loop, reference #4 is the d-ring(s), and reference #5 refers to the eyelets or holes.

FIG. 1b shows a view of the inside plane of a finished fabric-covered pet collar.

FIG. 1c shows a view of the outside plane of the fabric-covered pet collar with the turn back end for hardware open. The turn back is referenced as #6.

FIG. 1d shows a view of the inside plane of a fabric-covered pet collar with the turn back end for hardware open. See reference #6.

FIGS. 2a through 2i show each view in sequential order, the specific method of constructing and finishing of a fabric-covered pet collar.

FIG. 2a shows the outside collar band fabric strip with the fabric placed face down. The illustrated view (underside of the fabric up) is pre-fused with a fusible web product such as stitch witchery or web 3 or any other equivalent product, which fuses fabrics together when heat is applied with an iron or other pressing machine. A light pencil line is drawn at one end of the fabric strip to indicate a distance to fold to. Refer to # 7. Reference #6 indicates the additional length planned for turning back. The additional length is about 2″ to 5″ inches.

FIG. 2b shows the inside collar band with the fabric face placed down. The illustrated view (underside of the fabric up) is pre-fused with the fusible web product. A light pencil line is drawn at one end of the fabric strip to indicate a distance to fold to. Refer to #7. Note that the inner band of FIG. 2b is about 2″ to 5″ shorter than the outer band in FIG. 2a.

FIG. 2c shows the four specific folding steps for creating the pointed end of the collar. These steps are applied to both the outer fabric band in FIG. 2a and the inner fabric band in FIG. 2b and are illustrated and labeled as step 1, step 2, step 3, and step 4. In step 1, the shaded area referenced by #9 is folded over the to the light pencil line referenced by #8. Step 2 shows the now folded side fused down (or it can be glued down) and also indicates the extra allowance, which will fold over the inner banding, referenced by #10. In this case, the fold over allowance is a ¼′. In step 3, a new pencil line is drawn from pencil line #8 to the opposite fabric edge on a 45% angle. See reference #11. Step 4 shows the other side being folded over and fused or glued down. The completed folding process is shown with what will be the side band turn over allowance, referenced by #10. This is the exclusive finishing method for the point end of the collar.

Note: The light pencil line, which indicates the distance to fold to and referenced as #7, will vary depending on the width of the collar band and the fabric being used. The distance must be more than half the measurement of the fabric bandwidth. Thicker fabrics will require a little more folding distance because the thickness the fabric uses up length in folding over.

FIG. 2d shows a view of the inner banding product such as ban-rol waistband or stripped vinyl being applied to the inside of the outer fabric band. Reference #12 refers to the banding product. The banding is narrowed (trimmed about 1/16″ on either side about ½″ from the end opposite the pointed end) as shown in the illustration and numbered #13. It is also cut ¼″ shorter than the self-fabric. See reference #14. A small square of self-fabric is fused to the pointed end to hold and fill the hollow region of the point. See reference #15. The fold over allowance is referenced as #10. The fold over fabric distance can be from ¼″ up to half the width of the finished band. Reference #14 refers to the fold over fabric allowance at the end of the band, refer to #14. It is first folded over the end of the band, and then the sides referenced by #10 are folded and fused or glued over the sides of the band. This step is what cleans the raw edges of the filler banding to create the perfectly clean side plane of the collar. Note that the outer collar bands' additional length is what comprises what will become the clean turn back for the hardware and is referenced by number #6. This is the exclusive clean finishing method developed by Smart Design.

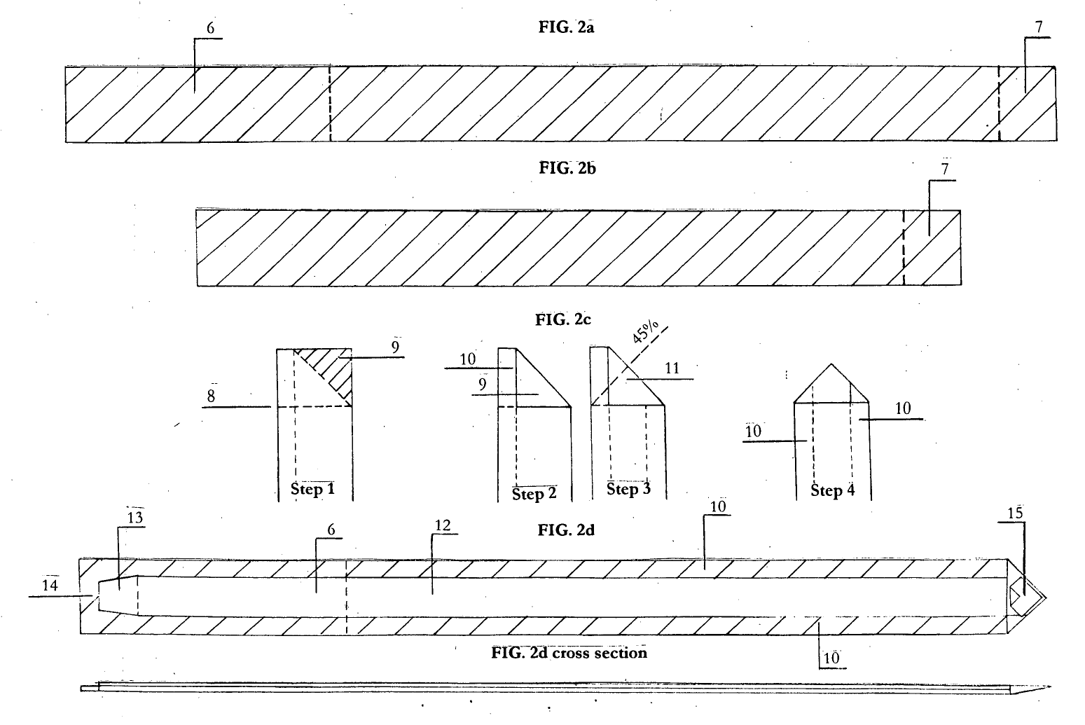

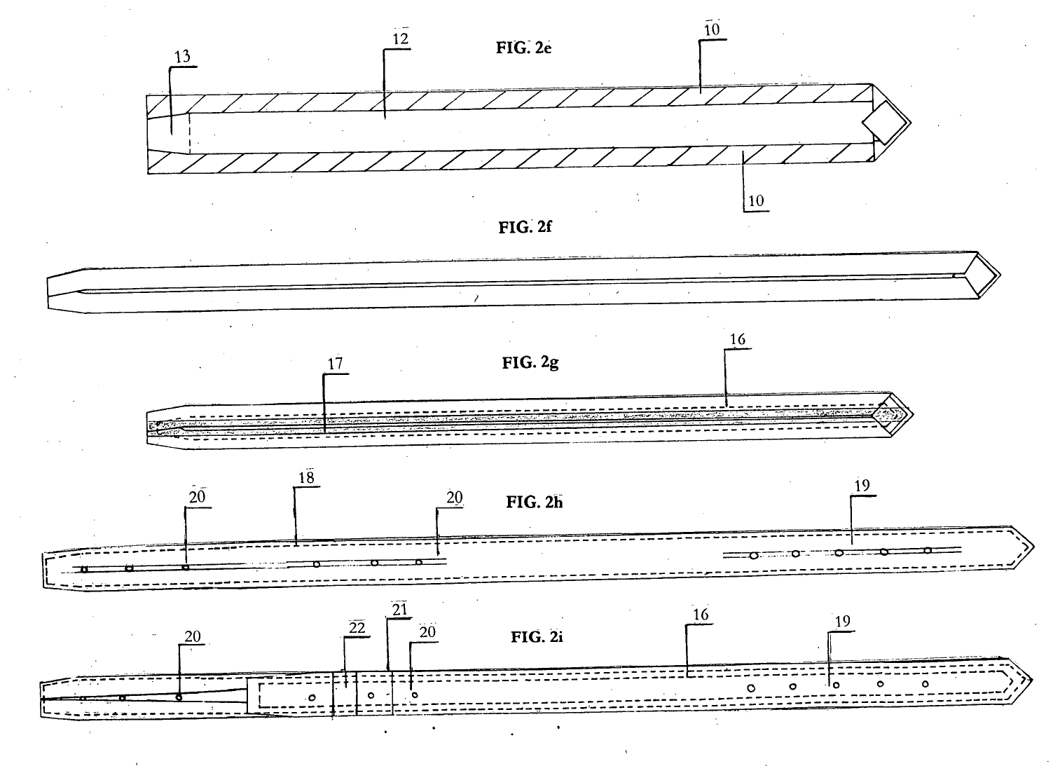

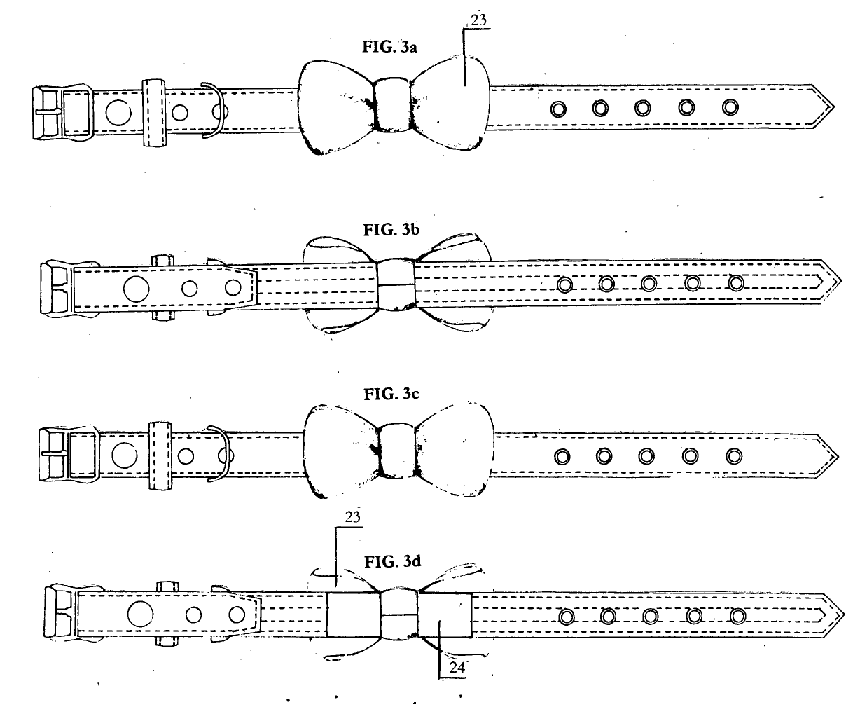

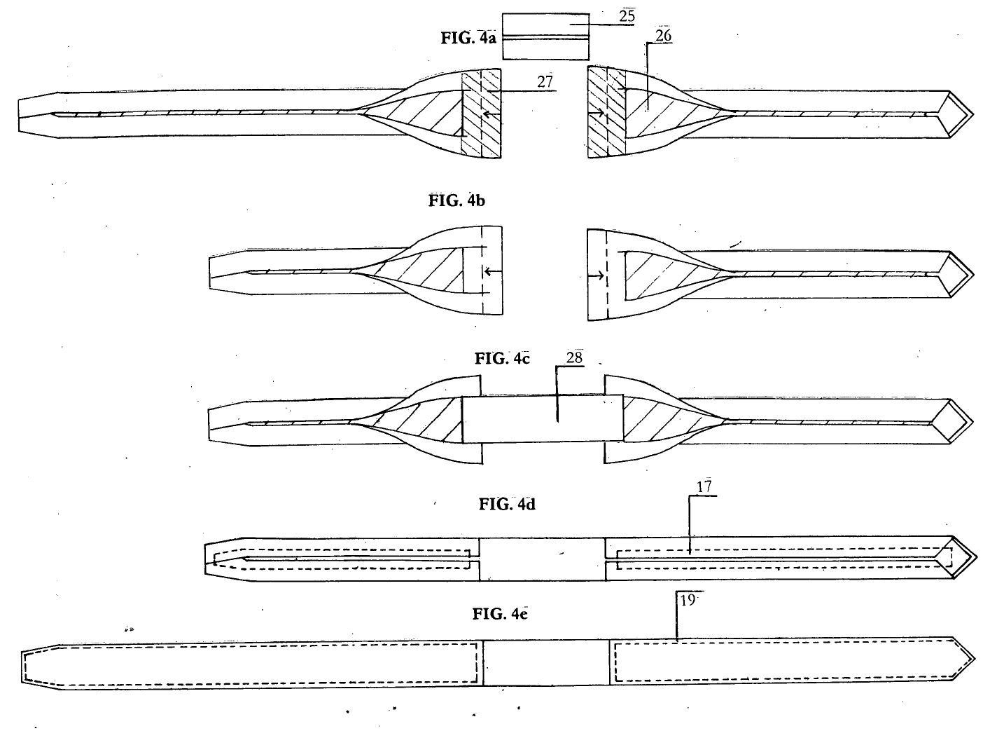

Note: The decision for inner banding thickness (number of layers) can vary in accordance with fabric type. FIG. 2D cross section illustrates an inner banding thickness of 1 layer. The variance can apply to the outer collar band and the inner collar band or it can apply to only one of them. For example, with lightweight fabrics, it may be desirable to use 2 thicknesses of banding. It may also be desirable to use a double layer of banding when designing collars for larger pets, such as very large and strong dogs. With heavier fabrics, it may be desirable to use only 1 thickness of banding. Fabrics vary considerably in weight and density and need to be considered individually.

FIG. 2e shows a view of inner banding being applied to the inside of the inner fabric band. The banding is narrowed (trimmed about 1/16″ on either side about ½″ from the end) into the illustrated shape and numbered #13. The banding is cut the same length as the self-fabric. The inner banding in this case is a single thickness. The fold over fabric allowance is referenced by #10 and will be folded and fused or glued over the banding at the sides.

FIG. 2f shows the closed inside view of the outer collar band. The turn over allowance (approximately ¼″ on either side of the band and at the end of the band), referenced by #10 and #14 have been folded over the banding and heat-steamed pressed with an iron, closed. Glue may also be used.

FIG. 2g shows the closed view of the inside of the inner collar band. The turn over allowance (approximately ¼″ on either side of the band), referenced by #10 have been folded over the banding and heat-steamed pressed with and iron or other pressing machine, closed. Glue may be used. The collar band is top stitched about 3/16″ away from the band edge and is referenced by #16. This functional topstitching prevents puckering to the inside collar band when it is wrapped around the pets' neck. A thin strip of fusible webbing about ¼″ to 1″ wide is fused down the center of the inner collar band or a thin strip of glue may be applied in the same manner. This will set the two bands together with raw edges to the inside. Reference #17.

FIG. 2h shows the outer collar band from the outer band view after fusing or gluing and edge stitching the clean inner band and clean outer band together at approximately 3/32″ from the cleaned edge. Reference #18. The collar band is then marked for the hardware placement with an erasable fabric marking pencil. It should be noted that the number of eyelets and position of the eyelets could vary from style to style. The eyelet markings have been referenced by #19. The rivet markings have been referenced by reference #20.

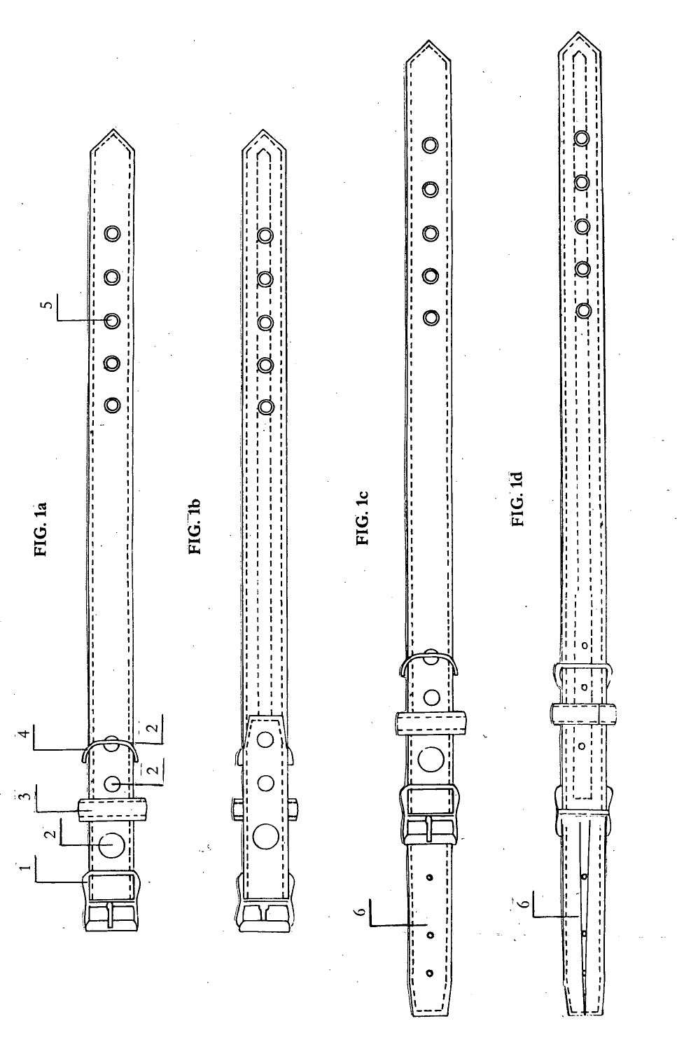

FIG. 2i shows the inner collar band being marked for d-ring, reference #21 and belt loop placement, reference #22 with an erasable fabric marking pencil. The eyelet marks are punched through with a screw punch, reference #19. Tiny holes are punched through the rivet makings with a screw punch, reference #20. The belt loop is cut to a specified length and glued with permanent fabric glue into place at the belt loop markings, referenced by #22. The d-ring is slid on from the pointed end and the buckle is slid on from the turn back end. The eyelets are placed in the pre-punched holes and permanently set with a key press machine. Holes can also be drilled or burned through. Refer back to replacement sheet ⅕ of the drawings of FIG. 1b, number #6 which illustrates the turn back for the hardware which have been numbered respectively #1(buckle), 2 (rivets), #3(belt loop), #4(d-ring), and #5 (eyelets) in FIG. 1a.

FIGS. 3a through 3d show the views of two features, which can be applied to the fabric-covered pet collar.

FIG. 3a shows the outside collar band view of a finished fabric-covered pet collar with an added feature, the bow, referenced in design patent application 29/199,520, filed on Feb. 18, 2004 for the Bow collar, a luxury pet collar designed and created by Smart Design of Los Angeles, Calif. The bow is referenced by #23.

FIG. 3b shows the inside collar band view of a finished fabric-covered pet collar with the added feature, the bow.

FIG. 3c shows an outer collar band view of a finished fabric-covered pet collar specifically for cats, with an added feature, the bow and another added feature, the safety elastic inset.

FIG. 3d shows the inner collar band view of a finished fabric-covered pet collar, specifically for cats, with an added feature, the bow and an added feature, the safety elastic inset referenced by #24.

FIGS. 4a through 4e show the specific steps in constructing the safety elastic insert specifically for cat collars having the Bow collar design feature referenced in design application 29/199,520.

FIG. 4a shows the outer collar band having a 1″ section cut out from the mid band, reference #25. The self-fabric is peeled back from each collar band segment so that the inner banding can be trimmed ½″ shorter than the self-fabric, reference #26. This allows for a ¼″ fabric turn back to clean the segment edges. See reference #27. The 1″ section is discarded.

FIG. 4b shows the inner collar band having the section cut out from the mid band. The self-fabric is peeled back from each collar band segment so that the inner banding can be trimmed ½″ shorter than the self-fabric. This allows for a ¼″ fabric turn back to clean the segment edges. Essentially, the same steps are applied to both outer and inner collar bands.

FIG. 4c shows a piece of elastic about 1 and ½ in length after being placed and fused or glued down on each clean segment of the inner collar band. Reference #28. The ¼″ side turn back allowances are folded back over the elastic inset as shown in the following FIG. 4d.

FIG. 4d shows the inside of the inner collar band after setting the elastic with edge-stitching at 3/16″ as in step 2g of 2a through 2i to prevent puckering to the fabric of the inner collar band when wrapped around the pets' neck. And is referenced by #17.

FIG. 4e shows the outer collar band having been fused or glued to the inner collar band with the elastic inset. The outer collar band and the inner collar band are then edge stitched together at about 3/32″ as illustrated and described in step 2h of 2a through 2i and is referenced by #19.

Refer back to FIGS. 3c and 3d which show a finished, fabric-covered pet collar with the Bow collar design feature and the safety elastic, especially for cat collars, having been finished in the manner described and illustrated in FIG. 4a through 4e. The bow feature will have been slid on from the pointed end to be positioned over the elastic.

1. A band structure specifically constructed and finished with the specific method developed by Smart Design of Los Angeles, Calif., which produces the following particular structure:
(a) a structure which is comprised of 2 separate pieces of filer banding material(s) which have been wrapped around by fashionable fabric or material and put together with stitches to make a singular banding having 3 clean planes; the inside plane, the outside plane, and the side plane or cross section plane wherein:
(b) the said singular banding has had one or both ends finished by the particular folding method developed by Smart Design of Los Angeles, Calif. which creates a shaped triangular shape and further:
(c) the said singular band has had one or both ends finished with a particular method developed by Smart Design of Los Angeles, Calif. which creates a shaped turn back structure for the application of hardware.

2. The band structure in claim 1 wherein specific additional functional stitching is added to the inside band to prevent puckering to the fabric when it is wrapped around the pets' neck.

3. The band structure in claim 1 wherein an additional added feature, a bow, has been applied to the finished collar.

4. The band structure in clam 1 wherein an additional added feature, a safety elastic inset, has been applied to the finished structure.
